(19) United States
(12) Patent Application Publication
(10) Pub. No.: US 2025/0157183 A1
(43) Pub. Date: May 15, 2025

(54) IMAGE PROCESSING DEVICE, METHOD, AND PROGRAM

(71) Applicant: NEC Corporation, Tokyo (JP)

(72) Inventor: Yoshikazu WATANABE, Tokyo (JP)

(73) Assignee: NEC Corporation, Tokyo (JP)

(21) Appl. No.: 18/907,953

(22) Filed: Oct. 7, 2024

(30) Foreign Application Priority Data
Nov. 10, 2023 (JP) 2023-192121

(51) Int. Cl. G06V 10/75; G06V 20/52

(52) U.S. Cl. CPC G06V 10/751; G06V 20/52

(57) ABSTRACT

The image processing device includes an object position prediction unit that predicts a position of an object in a new input image based on a position of the object detected in a past input image, an object detection target area determination unit that determines an object detection target area in the new input image based on the prediction result of the object position prediction unit, and an object detection unit that performs object detection on the object detection target area determined by the object detection target area determination unit.

This application is based upon and claims the benefit of priority from the prior Japanese Patent Application No. 2023-192121, filed Nov. 10, 2023, the entire contents of which are incorporated herein by reference.

### BACKGROUND OF INVENTION

### Field of the Invention

This present disclosure relates to technology for processing images.

### Description of the Related Art

One of the major tasks using machine learning is object detection in images. The object detection task generates a list of pairs of the position and class (type) of objects present in an image. In recent years, object detection tasks using deep learning have been widely used. For example, Patent Literature 1 discloses a technique related to the detection of object positions using a neural network.

In the training phase of machine learning for object detection tasks, training images and information about target objects in each image are provided as ground truth data. The information about the target objects is selected according to the object detection task's specifications. For example, the information includes coordinates of four vertices of a rectangular area (bounding box (BB)) containing the target object and the class of the target object. The following description uses a BB and a class as examples of information about the target objects. The object detection task generates a trained model through machine learning, such as deep learning, using the training images and information about the target object.

In the detection phase of the object detection task, a trained model is applied to an image containing the target objects to infer the target objects in the image. The object detection task outputs a pair of a BB and a class for each target object in the image. Additionally, the object detection task may also output an evaluation result of the object detection result, such as confidence or score.

For example, a surveillance system that monitors people and vehicles can be constructed by using images output from surveillance cameras as input to the object detection task, detecting the positions and classes of people and vehicles shown in the images.
[Patent Literature 1] Japanese Patent Application Publication No. 2019-036008

### SUMMARY OF INVENTION

Object detection processing is required to have high throughput. For example, a system that performs object detection processing on images output from surveillance cameras needs to operate at a sufficiently high frame rate to prevent missed detections. Low throughput can lead to increased equipment numbers, higher costs, and increased power consumption.

The technology disclosed in Patent Literature 1 aims to improve the accuracy of object position detection by correcting information obtained in an estimation process based on movement information of objects acquired from an image sequence. Therefore, the technology described in Patent Literature 1 cannot be expected to improve throughput.

The present disclosure has been made in view of these problems. The purpose of the present disclosure is to provide an image processing device, method, and program that improve the throughput of object detection processing.

A preferred aspect of the image processing device includes an object position prediction means that predicts a position of an object in a new input image based on a position of the object detected in a past input image, an object detection target area determination means that determines an object detection target area in the new input image based on the prediction result of the object position prediction means, and an object detection means that performs object detection on the object detection target area determined by the object detection target area determination means.

A preferred aspect of the image processing method includes predicting a position of an object in a new input image based on a position of the object detected in a past input image, determining an object detection target area in the new input image based on the prediction result, and performing object detection on the determined object detection target area.

A preferred aspect of the image processing program causes a computer execute an object position prediction process that predicts a position of an object in a new input image based on a position of the object detected in a past input image, an object detection target area determination process that determines an object detection target area in the new input image based on the prediction result of the object position prediction process, and an object detection process that performs object detection on the object detection target area determined by the object detection target area determination process.

According to the present disclosure, the throughput of object detection processing can be improved.

### BRIEF DESCRIPTION OF THE DRAWINGS

FIG. 1 It depicts a block diagram showing an example configuration of an image processing device according to the present disclosure.

FIG. 2 It depicts a flowchart showing an example operation of object detection processing in the image processing device according to the present disclosure.

FIG. 3 It depicts a flowchart showing an example operation of object detection processing in the image processing device according to the present disclosure.

FIG. 4 It depicts a flowchart showing an example operation of object detection processing in the image processing device according to the present disclosure.

FIG. 5 It depicts a flowchart showing an example operation of object detection processing in the image processing device according to the present disclosure.

FIG. 6 It depicts a block diagram showing an example hardware configuration.

FIG. 7 It depicts a block diagram showing an example configuration of the image processing device according to the present disclosure.

FIG. 8 It depicts a flowchart showing an example operation of object detection processing in the image processing device according to the present disclosure.

FIG. 9 It depicts a block diagram showing an overview of the image processing device according to the present disclosure.

### DESCRIPTION OF THE PREFERRED EMBODIMENTS

Technologies related to object detection tasks using deep learning are disclosed in the following documents 1 to 3. However, technologies related to improving the throughput of object detection processing are not disclosed in these documents. In other words, the technologies disclosed in the following documents alone cannot improve the throughput of object detection tasks.
Document 1: Shaoqing Ren, Kaiming He, Ross Girshick, Jian Sun, “Faster R-CNN: Towards Real-Time Object Detection with Region Proposal Networks”, online, Jan. 6, 2016, Cornell University, searched on Sep. 13, 2023, Internet <URL: https://arxiv.org/abs/1506.01497>
Document 2: Wei Liu, Dragomir Anguelov, Dumitru Erhan, Christian Szegedy, Scott Reed, Cheng-Yang Fu, Alexander C. Berg, “SSD: Single Shot MultiBox Detector”, online, Dec. 29, 2016, Cornell University, searched on Sep. 13, 2023, Internet <URL: https://arxiv.org/abs/1512.02325>
Document 3: Tsung-Yi Lin, Priya Goyal, Ross Girshick, Kaiming He, Piotr Dollar, “Focal Loss for Dense Object Detection”, online, International Conference on Computer Vision (ICCV), 2017, pp. 2980-2988, searched on Sep. 13, 2023, Internet <URL: https://openaccess.thecvf.com/content_ICCV_2017/papers/Lin_Focal_Loss_for_ICCV_2017_pa per.pdf>

Hereinafter, example embodiments of the present disclosure will be explained with reference to the drawings. Each drawing is for explaining the example embodiments. However, the example embodiments are not limited to the descriptions in the drawings. Similar components in the drawings are denoted by the same reference numerals. Repeated descriptions of similar components in the drawings may be omitted. In the drawings used for the following description, parts not related to the explanation of the example embodiments may be omitted or not shown.

### Example Configuration of the First Example Embodiment

Hereinafter, the first example embodiment will be explained with reference to the drawings.

In the first example embodiment, the image processing device predicts the position of an object in a next input image (that is, a new input image) based on the position of the object detected in a past input image. Additionally, the image processing device targets a predicted area for object detection processing. As a result, the amount of data targeted for object detection processing is reduced, reducing the computational load. Thus, it is expected that the throughput of object detection processing will be improved. Additionally, the delay in object detection processing is expected to be shortened.

### DESCRIPTION OF CONFIGURATION

The configuration of the first example embodiment will be explained with reference to the drawings.

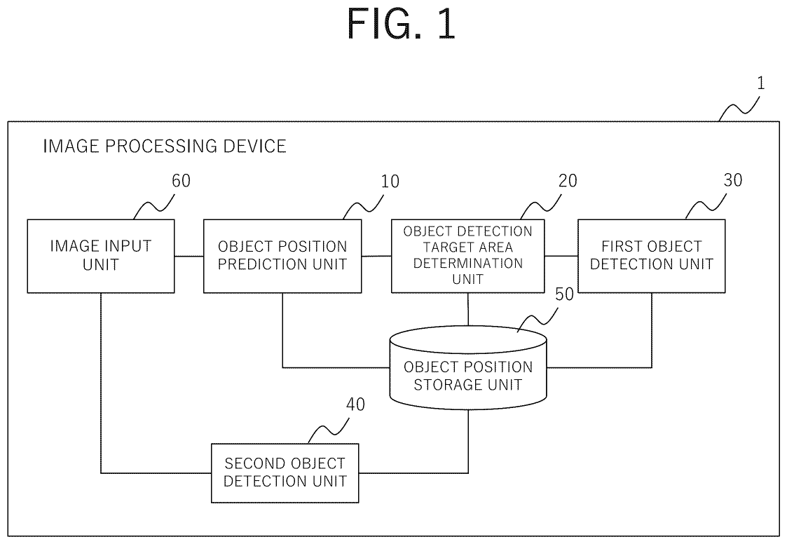

FIG. 1 is a block diagram showing an example configuration of an image processing device 1 according to the present disclosure. The image processing device 1 includes an object position prediction unit 10, an object detection target area determination unit 20, a first object detection unit 30, a second object detection unit 40, an object position storage unit 50, and an image input unit 60. The number and connection relationships of the components shown in FIG. 1 are examples. For example, the image processing device 1 may include a plurality of image input units 60.

The image processing device 1 may be configured using a computer device that includes a CPU (Central Processing Unit), main memory, and secondary storage device. In this case, the object position prediction unit 10, the object detection target area determination unit 20, the first object detection unit 30, the second object detection unit 40, the object position storage unit 50, and the image input unit 60 of the image processing device 1 shown in FIG. 1 are realized by the CPU executing processing according to a program stored in the secondary storage device. The hardware configuration of the image processing device 1 will be explained later.

In this example embodiment, an example will be explained in which the image processing device 1 uses an image as input and performs object detection for people in the image as an object. For example, the image processing device 1 performs an object detection task for people (a person detection task). Note that the object detection tasks executable by the image processing device 1 of the present disclosure are not limited to people.

In this example embodiment, the object position prediction unit 10 predicts a position of an object detected in a past (hereinafter referred to as a known object) in a next input image. The first object detection unit 30 detects a known object in the image based on the prediction results of the object position prediction unit 10.

The second object detection unit 40 performs object detection to prevent missing objects for which information indicating past positions has not been accumulated sufficiently to be used as input to the prediction by the object position prediction unit 10. These objects are also referred to as a new object. The operations of the object position prediction unit 10, first object detection unit 30, and second object detection unit 40 are not limited to these.

The object position prediction unit 10 uses position information indicating a past position of an object stored in the object position storage unit 50 as input for the prediction and predicts a position of the object in a next image input from the image input unit 60. Hereinafter, the image input from the image input unit 60 is referred to as an input image. The object position prediction unit 10 may also use position information of an object detected by the second object detection unit 40 as input for the prediction. An example in which the object position prediction unit 10 uses the position information of the object detected by the second object detection unit 40 for prediction will be explained later.

The object detection target area determination unit 20 determines an area in the input image where the first object detection unit 30 should execute object detection processing, using the prediction result of the object position prediction unit 10, the past position information of known objects stored in the object position storage unit 50, and information about new objects. Hereinafter, the area in the input image targeted for object detection processing by the first object detection unit 30 is referred to as an object detection target area. The object detection target area is a set of partial areas that are part of the entire area of the input image. Hereinafter, each partial area constituting the object detection target area is referred to as an individual object detection target area. The details of the individual object detection target areas will be explained later.

The first object detection unit 30 performs an object detection task using the image as input and outputs an object detection result. For example, the first object detection unit 30 performs object detection processing using only the area containing the predicted object position in the input image input from the image input unit 60. The first object detection unit 30 performs object detection processing using deep learning, for example. The first object detection unit 30 holds a trained model (specifically, a trained model stored in a predetermined storage medium) and applies the trained model to the input to perform inference. The first object detection unit 30 outputs a BB and class, and other information for each object as the object detection result. However, the operation of the first object detection unit 30 is not limited to this. For example, the first object detection unit 30 may hold a plurality of trained models. The first object detection unit 30 may switch the parameters used for inference (for example, the trained model used or the input size) according to the characteristics of the individual object detection target areas (for example, height or width of the area). For example, the first object detection unit 30 may perform inference using a smaller input size for individual object detection target areas with smaller heights or widths.

The second object detection unit 40 performs an object detection task on the input images input from the image input unit 60. The second object detection unit 40 outputs the object detection results obtained by performing the object detection task. The second object detection unit 40 performs object detection processing using deep learning, similar to the first object detection unit 30. The second object detection unit 40 may use a trained model different from the one used by the first object detection unit 30. For example, the second object detection unit 40 may use a lighter trained model than the one used by the first object detection unit 30. However, the operation of the second object detection unit 40 is not limited to this. The second object detection unit 40 may perform the object detection task intermittently on the input images input from the image input unit 60. For example, the second object detection unit 40 may perform the object detection task at predetermined intervals (for example, once per second).

The object position storage unit 50 stores information about objects (known objects) detected by the object detection target area determination unit 20 and the first object detection unit 30. The object position storage unit 50 also stores information about objects (new objects) detected by the second object detection unit 40. The object position storage unit 50 stores information about the objects, such as the bounding box, class, score, detection time, identifier of the input image in which the object was detected, and identifier of the image input unit 60 that generated the input image, all or a part of which may be stored.

The image input unit 60 generates images (that is, input images) to be processed by the image processing device 1. The image input unit 60 may be realized by a surveillance camera, for example. The image input unit 60 may use images captured by the camera as input images or images that have undergone preprocessing such as image processing or cropping. The image input unit 60 may input images output continuously from an external device at a predetermined frame rate as input images.

The method for predicting object positions by the object position prediction unit 10 will be explained.

Methods for predicting the future positions of objects from their past positions have been widely studied. For example, in the field of pedestrian position prediction, there is a research area called human trajectory prediction. Recently, deep learning-based methods for human trajectory prediction have been widely studied. Deep learning-based methods for human trajectory prediction perform inference using a trained model, with past movement trajectories as input, to predict future movement trajectories.

The object position prediction unit 10 may use any human trajectory prediction method to perform the object position prediction process. Many human trajectory prediction methods use aggregated information of the same person's movement trajectories as input to achieve high prediction accuracy. Additionally, many human trajectory prediction methods perform tracking processing to identify the same person from a plurality of images taken at different past times. The execution of tracking processing involves computational load. Therefore, applying a human trajectory prediction method requiring tracking processing to the image processing device 1 may lead to a decrease in processing throughput.

The object position prediction unit 10 may use a prediction method that does not require tracking processing instead of a prediction method that requires tracking processing. Hereinafter, an example of a prediction method that does not require tracking processing will be explained. The object position prediction unit 10 of this example embodiment uses the prediction method that does not require tracking processing explained below. This prediction method is also referred to as the first prediction method of this example embodiment. However, the prediction methods that the object position prediction unit 10 can use are not limited to the first prediction method of this example embodiment.

When using the position information of objects at multiple different times as input for prediction, tracking processing may be performed to use aggregated information of the same person's movement trajectory. In this case, the input for the prediction is not independent across the different times, and there are dependencies. On the other hand, when using only the position information of objects at each time as input for prediction without performing tracking processing, the input for the prediction is independent across the multiple times. The first prediction method of this example embodiment is a prediction method that does not require tracking processing. Therefore, the first prediction method of this example embodiment uses information that is independent of each other across multiple times as input for the prediction.

The first prediction method of this example embodiment uses the position information of objects in the input images at multiple past times as input. In this example, the number of past times (that is, observed times) is denoted as N_{obs(observation)}. The first prediction method of this example embodiment predicts the positions of objects in the input images at the next time. However, the prediction targets of the first prediction method of this example embodiment are not limited to this. For example, the first prediction method of this example embodiment may predict the positions of objects in the input images at multiple future times. The number of objects included in the input images can be any number.

The first prediction method of this example embodiment divides the input and output images (that is, prediction results) into predetermined sizes and manages the positions of objects in units of the divided areas (grids). For example, when the original image is full HD (High Definition) (1920×1080) and a predetermined size of 32×32 is used, the first prediction method of this example embodiment manages the positions using 60×34 grids.

The first prediction method of this example embodiment creates inference input data to be input into a trained model using the position information of objects in the input images at N_{obs} past times. The inference input data is, for example, a floating-point vector with the number of grids as dimensions. In this case, the inference input data contains a value of 1 for elements corresponding to grids where one or more objects are present, and a value of 0 for elements corresponding to grids where no objects are present. The output from the trained model (that is, the inference output data) is, for example, a floating-point vector with the number of grids as dimensions. In this case, the output from the trained model contains a high value for elements corresponding to grids where objects are predicted to be present with high probability.

The first prediction method of this example embodiment, for example, uses a predetermined threshold to predict, for each element of the inferred output data, that an object is present in a grid corresponding to that element when the value is equal to or greater than the threshold. Additionally, the first prediction method of this example embodiment predicts that no object is present in a grid corresponding to that element when the value is less than the threshold. The trained model used by the first prediction method of this example embodiment is, for example, generated by learning a prediction model using inference input data and inference output data generated from a ground truth dataset containing images and position information related to moving objects.

The first prediction method of this example embodiment may use a deep learning model, such as an RNN (Recurrent Neural Network) or an LSTM (Long Short Term Memory) network. The first prediction method of this example embodiment may also use a deep learning model using CNN (Convolutional Neural Network) or Transformer with input data obtained by concatenating past time series data in the channel direction.

The first prediction method of this example embodiment can predict the future positions of objects in an image without identifying, separating, or tracking individual objects even if multiple objects are present in an image at a certain time. In other words, the floating-point vectors for N_{obs} are independent of each other.

The method for determining the object detection target area by the object detection target area determination unit 20 will be explained.

The object detection target area determination unit 20 extracts the grids where objects are located from the prediction results (that is, information indicating the presence or absence of objects in the grids) by the object position prediction unit 10. The object detection target area determination unit 20 groups the adjacent grids among the extracted grids and creates a set of grids. However, the operation of the object detection target area determination unit 20 is not limited to this. The number of sets of grids can be 0, 1, or more than 1, corresponding to the positions where objects (groups) are predicted.

The object detection target area determination unit 20 may use the created grid sets as individual object detection target areas and the set of individual object detection target areas as the object detection target area. Additionally, the object detection target area determination unit 20 may determine the minimum-sized rectangle that includes the grid sets and use it as an individual object detection target area.

The object detection target area determination unit 20 may adjust the individual object detection target areas. For example, the object detection target area determination unit 20 may enlarge the height or width of the individual object detection target areas by a constant factor or add a constant value. Enlarging the individual object detection target areas helps avoid missed or incomplete detections when predictions are incorrect.

The object detection target area determination unit 20 checks whether the areas overlap for each pair of two individual object detection target areas. When they do overlap, the object detection target area determination unit 20 may merge the two individual object detection target areas (that is, resolve the overlap) into a single individual object detection target area. For example, the object detection target area determination unit 20 may determine the minimum rectangle that includes both individual object detection target areas as the merged individual object detection target area. Merging overlapping individual object detection target areas helps avoid double detections in object detection. The object detection target area determination unit 20 may perform adjustments of the aforementioned individual object detection target areas after resolving any overlaps.

When the object detection results by the second object detection unit 40 are available, the object detection target area determination unit 20 may update the existing object detection target areas using the position information of objects detected by the second object detection unit 40. The object detection target area determination unit 20 may also determine new object detection target areas using the position information of objects detected by the second object detection unit 40.

The object detection target area determination unit 20, for example, checks whether the bounding box of each detected object included in the object detection results from the second object detection unit 40 is contained within the object detection target area. When not included, the object detection target area determination unit 20 may add the bounding box of the detected object as an individual object detection target area and update the object detection target areas. At that time, the object detection target area determination unit 20 may perform the above-explained adjustment and merging of individual object detection target areas. The object detection target area determination unit 20 may treat detected objects included in the object detection results from the second object detection unit 40, which are not contained within the object detection target area, as new objects. In this case, the object detection target area determination unit 20 may store information about the new objects in the object position storage unit 50. Information about new objects may include position information such as bounding boxes and information that identifies them as new objects.

When information about new objects is stored in the object position storage unit 50, the object detection target area determination unit 20 may update the existing object detection target areas using the information about the new objects. The object detection target area determination unit 20 may also determine new object detection target areas using the information about the new objects.

The object detection target area determination unit 20 may update the object detection target areas by adding the bounding boxes of new objects as individual object detection target areas. However, since new objects may be moving, the object detection target area determination unit 20 may adjust the bounding boxes before using them as individual object detection target areas. For example, the object detection target area determination unit 20 may enlarge the bounding boxes by a predetermined value in all directions (that is, by adding or subtracting from the coordinate values). The object detection target area determination unit 20 may perform the above-explained adjustment and merging of individual object detection target areas.

The object detection target area determination unit 20 may update the information about new objects stored in the object position storage unit 50 using the object detection results for the input images input from the image input unit 60. The object detection results are expected to include detection results for the latest positions of new objects.

For each new object, the object detection target area determination unit 20 may search for corresponding detection results from the object detection results. The object detection target area determination unit 20 may update the information about the new objects stored in the object position storage unit 50 using the corresponding detection results. The object detection target area determination unit 20 may use any method to search for corresponding detection results for new objects. For example, the object detection target area determination unit 20 may calculate the IoU (Intersection over Union) between the new object and each object in the object detection results and use the object with the highest IoU as the corresponding detection result for the new object. When the object detection target area determination unit 20 cannot find corresponding detection results for new objects (for example, when the maximum IoU is below a predetermined threshold), it may delete the information about the new objects. The object detection target area determination unit 20 may also perform tracking processing for new objects to search for corresponding detection results in the object detection results.

The object detection target area determination unit 20 may delete the information about new objects stored in the object position storage unit 50 at any timing. For example, the object detection target area determination unit 20 may delete the information about new objects when it is determined that the information has been accumulated sufficiently to be used as input for the prediction by the object position prediction unit 10. The object detection target area determination unit 20 may determine that the information about new objects has been sufficiently accumulated when the first object detection unit 30 has performed object detection processing for new objects N_{obs} times or more.

### DESCRIPTION OF OPERATIONS

Next, an example operation of the image processing device 1 according to the first example embodiment will be explained with reference to the drawings.

### (A) Operation of Object Detection Processing Based on Prediction

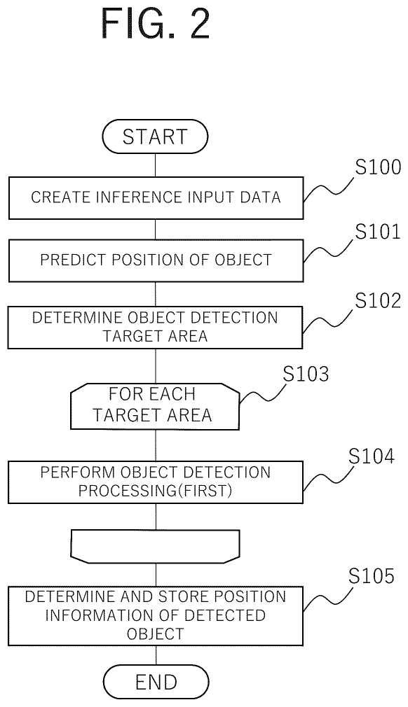

FIG. 2 is a flowchart showing an example operation of object detection processing in the image processing device 1 according to the present disclosure. The operation shown in FIG. 2 includes the operation of the object detection target area determination unit 20 determining the object detection target areas based on the position information of objects (known objects) detected in the past stored in the object position storage unit 50. The operation shown in FIG. 2 also includes the operation of the first object detection unit 30 performing object detection processing for each individual object detection target area constituting the object detection target areas.

The image processing device 1 starts this operation, for example, each time an input image is input from the image input unit 60. However, when the second object detection unit 40 performs object detection (for example, at predetermined time intervals), the image processing device 1 executes the object detection processing operation (B) using the second object detection unit 40 instead of this operation.

The object position prediction unit 10 obtains the position information of objects (known objects) in the N_{obs} most recent input images from the object position storage unit 50. The object position prediction unit 10 creates inference input data to be input into the trained model of the first prediction method of this example embodiment based on the obtained position information (step S100).

Next, the object position prediction unit 10 performs inference using the trained model with the inference input data created in step S100 and predicts positions of objects (step S101).

Next, the object detection target area determination unit 20 determines the object detection target areas based on the prediction results obtained in step S101 (that is, information indicating the presence or absence of objects in the grids) (step S102).

Next, the first object detection unit 30 performs object detection processing for each individual object detection target area obtained in step S102 using the input image input from the image input unit 60 (steps S103 to S104). For example, the first object detection unit 30 performs object detection processing using only the images corresponding to the individual object detection target areas. The processing of step S104 is repeated until it is executed for all individual object detection target areas. The first object detection unit 30 converts the bounding box information obtained as the result of the object detection processing from coordinates in the individual object detection target areas to coordinates in the input image input from the image input unit 60.

Next, the first object detection unit 30 stores position information of the objects obtained in steps S103 to S104 in the object position storage unit 50 (step S105). The first object detection unit 30 may also store information identifying the input image, such as the time the input image was generated, the identifier of the input image, and the identifier of the image input unit 60, along with the position information of the objects. The first object detection unit 30 may also store the input image itself in the object position storage unit 50.

### (B) Operation of Object Detection Processing Using the Second Object Detection Unit

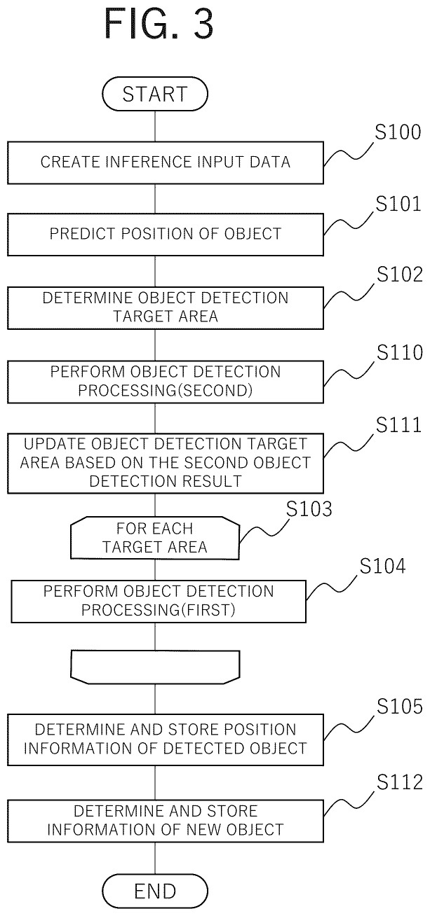

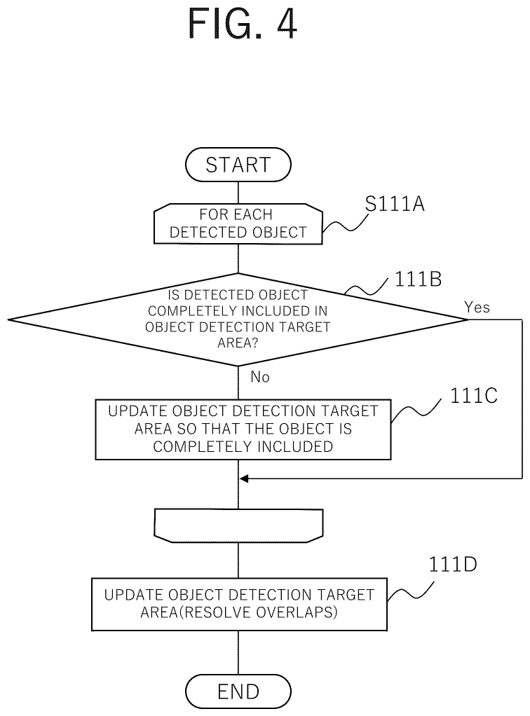

FIG. 3 and FIG. 4 are flowcharts showing an example operation of object detection processing in the image processing device 1 according to the present disclosure. FIG. 3 and FIG. 4 show an example operation of object detection processing using the second object detection unit 40. This operation includes the operation of the object detection target area determination unit 20 determining the object detection target areas based on the position information of objects (known objects) detected in the past stored in the object position storage unit 50 and the object detection results by the second object detection unit 40. This operation also includes the operation of the first object detection unit 30 performing object detection processing for each individual object detection target area constituting the object detection target areas.

The image processing device 1 executes this operation instead of the object detection processing operation (A) based on prediction when the second object detection unit 40 performs object detection when an input image is input from the image input unit 60. In FIG. 3 and FIG. 4, the same steps as in the object detection processing operation (A) based on prediction are denoted by the same step numbers, and their descriptions are omitted.

The image processing device 1 performs the same processing as in steps S100 to S102 shown in FIG. 2.

Next, the second object detection unit 40 performs object detection processing using the input image input from the image input unit 60 (step S110).

Next, the object detection target area determination unit 20 updates the object detection target areas determined in step S102 based on the object detection results obtained in step S110 (step S111). The details of step S111 will be explained later.

Next, the first object detection unit 30 performs object detection processing for each individual object detection target area obtained in step S111 using the input image input from the image input unit 60 (steps S103 to S104). For example, the first object detection unit 30 performs object detection processing using only the images corresponding to the individual object detection target areas. The processing of step S104 is repeated until it is executed for all individual object detection target areas.

Next, the first object detection unit 30 stores position information of the objects obtained in steps S103 to S104 in the object position storage unit 50 (step S105).

Next, the object detection target area determination unit 20 stores information about new objects (for example, bounding box information) processed in step S111C (the details of which will be explained later) in the object position storage unit 50 (step S112).

Next, the details of step S111 shown in FIG. 3 will be explained with reference to FIG. 4.

The object detection target area determination unit 20 performs steps S111B to S111C described below for each detected object obtained in step S110 (step S111A).

The object detection target area determination unit 20 checks whether the bounding box of the detected object is completely included in the object detection target area determined in step S102 (step S111B). When it is completely included (Yes in step S111B), the object detection target area determination unit 20 terminates the processing for the detected object.

When it is not completely included (No in step S111B), the object detection target area determination unit 20 identifies the detected object as a new object. The object detection target area determination unit 20 updates the object detection target area so that the bounding box of the detected object identified as a new object is completely included (step S111C).

When there are overlapping individual object detection target areas in the object detection target areas updated in steps S111A to S111C, the object detection target area determination unit 20 merges them (step S111D).

(C) Operation of Object Detection Processing Using Information about a New Object

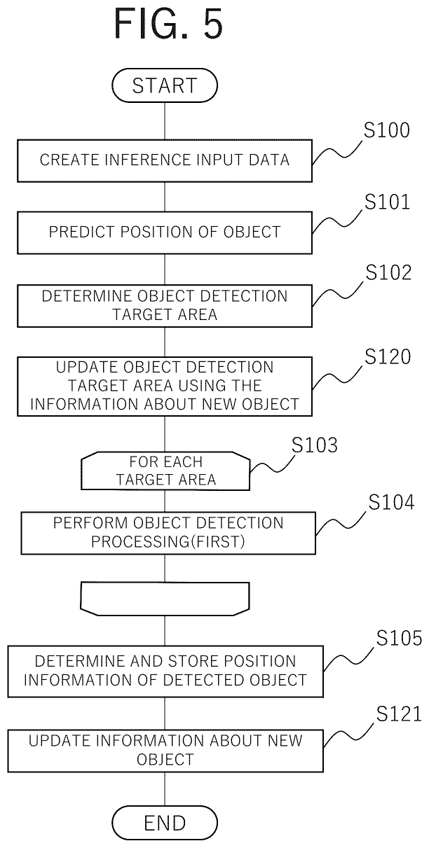

FIG. 5 is a flowchart showing an example operation of object detection processing in the image processing device 1 according to the present disclosure. FIG. 5 shows an example operation of object detection processing using information about a new object. This operation includes the operation of the object detection target area determination unit 20 determining the object detection target areas using the position information of objects (known objects) detected in the past stored in the object position storage unit 50 and the detection results of new objects obtained by the object detection processing operation (B) using the second object detection unit 40. This operation also includes the operation of the first object detection unit 30 performing object detection processing for each individual object detection target area constituting the object detection target areas.

This operation is executed instead of the object detection processing operation (A) based on prediction until the next input image and the subsequent N_{obs}-1 input images of the input image for which the object detection processing operation (B) using the second object detection unit 40 was performed are processed. After processing a total of N_{obs} input images, including the input image for which the object detection processing operation (B) using the second object detection unit 40 was performed, the information about the new object is considered to be sufficiently accumulated to be used as input for the prediction by the first prediction method of this example embodiment. Therefore, the new object is treated as a known object. Additionally, the information about the new object is deleted from the object position storage unit 50.

In FIG. 5, the same steps as in the object detection processing operation (A) based on prediction are denoted by the same step numbers, and their descriptions are omitted.

The image processing device 1 performs the same processing as in steps S100 to S102 shown in FIG. 2.

Next, when information about new objects is stored in the object position storage unit 50, the object detection target area determination unit 20 updates the object detection target areas determined in step S102 using the information about the new objects (step S120).

Next, the first object detection unit 30 performs object detection processing for each individual object detection target area obtained in step S120 using the input image input from the image input unit 60 (steps S103 to S104). For example, the first object detection unit 30 performs object detection processing using only the images corresponding to the individual object detection target areas. The processing of step S104 is repeated until it is executed for all individual object detection target areas.

Next, the first object detection unit 30 stores position information of the objects obtained in steps S103 to S104 in the object position storage unit 50 (step S105).

Next, the object detection target area determination unit 20 updates information about new objects stored in the object position storage unit 50 using the position information (object detection results) obtained in steps S103 to S104 (step S121). For example, the object detection target area determination unit 20 searches for an object with the highest IoU with the new object stored in the object position storage unit 50 from the object detection results. The object detection target area determination unit 20 updates information about the new objects using the position information of the searched object. The object detection target area determination unit 20 may delete the information regarding new objects from the object position storage unit 50 when the next input image and the subsequent N_{obs}-1 input images of the input image for which the object detection processing operation (B) using the second object detection unit 40 was performed.

Based on the above operations, the image processing device 1 performs object detection processing on the input images input from the image input unit 60.

### DESCRIPTION OF EFFECTS

Next, the effects of the first example embodiment will be explained.

The image processing device 1 according to the first example embodiment can improve the throughput of object detection processing. Additionally, the image processing device 1 according to the first example embodiment can shorten the delay in object detection processing. The reasons are as follows.

The object position prediction unit 10 of the image processing device 1 according to the first example embodiment predicts positions of objects in an input image. The object detection target area determination unit 20 determines individual object detection target areas, which are partial areas of the input image, based on the predicted positions of the objects. The first object detection unit 30 performs object detection processing for each individual object detection target area. The size of the individual object detection target areas is expected to be smaller than the input image. In other words, the image processing device 1 according to the first example embodiment reduces the amount of data to be processed for object detection, thereby reducing the computational load. Therefore, the throughput of object detection processing is expected to improve. Additionally, the delay in object detection processing is expected to shorten. In other words, the image processing device 1 according to the first example embodiment enables quick responses to target objects by shortening the time from when the target objects appear in the image to when they are detected (that is, shortening the delay).

### Variations

In the above description, an example was shown where the time interval applied to the input and output for prediction by the object position prediction unit 10 is the same as the generation interval of the input images by the image input unit 60. However, the present disclosure is not limited to this. The respective units constituting the image processing device 1, including the object position prediction unit 10 and the image input unit 60, may operate at different time intervals. For example, each unit constituting the image processing device 1 may operate using the latest available information at the time each unit operates.

The first object detection unit 30 and the second object detection unit 40 may output scores (or confidence or certainty) for each detected object as object detection results. Each unit constituting the image processing device 1 may filter the detection results based on a predetermined threshold and score when utilizing the object detection results. The predetermined threshold may vary depending on the application.

In the above description, an example was shown where the trained model used by the first prediction method of this example embodiment is generated by learning a prediction model using inference input data and inference output data generated from a ground truth dataset containing images and position information related to moving objects. However, the present disclosure is not limited to this. During model training, the ground truth position information included in the ground truth dataset may be transformed, processed, or augmented. For example, the positions of objects may be expanded vertically and horizontally similar to the adjustment of the object detection target areas. Training in this manner may result in larger predicted positions than the actual object positions, but it is expected to reduce missed detections. Additionally, within the N_{obs} frames used for a single prediction, the positions of objects may be shifted, flipped vertically or horizontally, rotated, or scaled. Objects may also be expanded or contracted in the time direction. In other words, the speed of movement of objects may be slowed down or sped up. For example, one frame may be extracted from every two N_{obs} frames in the ground truth data and used as input for prediction. In this case, the objects in the frames will appear to move at twice the speed.

In the above description, an example was shown where the object position prediction unit 10 applies the first prediction method of this example embodiment to all known objects. However, the present disclosure is not limited to this. The object position prediction unit 10 may apply another prediction method different from the first prediction method of this example embodiment to some objects. For example, the object position prediction unit 10 may apply a prediction method involving tracking processing. Generally, prediction methods involving tracking processing have higher computational loads but improved prediction accuracy. Therefore, using a prediction method involving tracking processing is expected to improve detection accuracy (for example, reducing missed detections due to prediction failures). The object position prediction unit 10 may apply a different position prediction method to objects with scores below a predetermined threshold in the object detection results. Additionally, the object position prediction unit 10 may divide the input image into multiple areas and apply different prediction methods or switch prediction parameters for each area. The configuration information and switching patterns of the areas may be provided in advance.

In the above description, an example was shown where both the second object detection unit 40 and the first object detection unit 30 perform object detection processing in the object detection processing operation (B) using the second object detection unit. However, the present disclosure is not limited to this. In the object detection processing operation (B) using the second object detection unit, steps S111 and object detection processing by the first object detection unit 30 (steps S103 and S104) may be omitted. In this case, the object detection results by the second object detection unit 40 in step S110 may be treated as the object detection results by the first object detection unit 30. Alternatively, the first object detection unit 30 may perform object detection processing for the entire area of the input images instead of the second object detection unit 40 in step S110.

In the above description, an example was shown where the input images used as input for prediction and the input images targeted for object detection (or the input images used for output as prediction results) are input from the same image input unit. However, the present disclosure is not limited to this. For example, the image processing device 1 may include multiple image input units 60 (for example, image input unit 60A and image input unit 60B). In this case, the object position prediction unit 10 may use positions of objects in the input images from image input unit 60A as input for prediction and predict positions of objects in the input images from image input unit 60B. The trained model used for inference by the object position prediction unit 10 may be trained with this configuration in mind. The difference in the shooting range (or angle of view) between image input unit 60A and image input unit 60B may be fixed. Additionally, information indicating the difference in the shooting range (or angle of view) between image input unit 60A and image input unit 60B may be used during training.

In the above description, an example was shown where the image processing device 1 performs an object detection task. However, the present disclosure is not limited to this. The image processing device 1 may perform other tasks, such as pose estimation or segmentation. For example, the first object detection unit 30 may perform other tasks in addition to or instead of the object detection task. Similarly, the second object detection unit 40 may perform other tasks in addition to or instead of the object detection task. When the task does not directly generate position information of objects, the image processing device 1 may generate the position information of objects or substitute information required for the prediction operation by the object position prediction unit 10 based on the output of the task. For example, when the task is a pose estimation task, the output may include information (type, position, etc.) about the joint points of a person in the input images. The image processing device 1 may generate a person rectangle from the obtained joint points and use it as the position information of the object.

Additionally, for example, the first object detection unit 30 may perform an image recognition task instead of the object detection task. Generally, image recognition tasks have lower processing loads compared to object detection tasks and are expected to improve throughput. The first object detection unit 30 may switch between using image recognition tasks or not based on the characteristics of the individual object detection target areas. For example, the first object detection unit 30 may select image recognition tasks in the following cases:

When the size of the individual object detection target area is below a predetermined threshold

When the number of objects expected to be present in the individual object detection target area is one or less

When the individual object detection target area has not undergone the merging (resolving overlaps) process

In the above description, an example was shown where the image processing device 1 executes the object detection processing operation (A) based on prediction each time an input image is input from the image input unit 60. However, the present disclosure is not limited to this. For example, the image processing device 1 may omit the execution of the operation when it can be pre-determined that there are no known objects and the resulting object detection target area from the prediction is empty. This is expected to reduce the load related to the prediction.

In the above description, an example is shown where the image input unit 60 generates an input image. However, the present disclosure is not limited to this. The image input unit 60 may receive compressed image data from an external device and decode the image data to generate the input image. The image input unit 60 may decode compression formats such as JPEG (Joint Photographic Experts Group) and MPEG (Moving Picture Experts Group). Additionally, the image input unit 60 may switch the generation method using prediction results for past input images.

For example, when there are no known objects and it can be pre-determined that the resulting object detection target area from the prediction is empty, the image input unit 60 may omit the decoding process or perform the decoding process using a low-load, low-quality decoding method. The image input unit 60 may perform the decoding process only for the object detection target areas. For example, the image input unit 60 may perform decoding processing for each individual object detection target area or perform decoding processing only for the minimum rectangular area including all individual object detection target areas. The image input unit 60 may fill the areas not subjected to decoding processing with dummy images (for example, black-filled images). Additionally, the image input unit 60 may output the area information to the constituent elements that use the input images and allow them to refer to the area information for the areas not subjected to decoding processing. Additionally, the image input unit 60 may generate the input images normally or perform the decoding process using a low-load, low-quality decoding method when it is the timing for executing the object detection processing operation (B) using the second object detection unit 40.

### Hardware Configuration

In the above description, an example was shown where the object position prediction unit 10, the object detection target area determination unit 20, the first object detection unit 30, the second object detection unit 40, the object position storage unit 50, and the image input unit 60 are included in the same device (image processing device 1). However, the first example embodiment is not limited to this.

For example, the image processing device 1 may be configured by connecting devices with functions corresponding to each configuration via a predetermined network.

Each component of the image processing device 1 may be composed of hardware circuits. Alternatively, multiple components of the image processing device 1 may be composed of a single piece of hardware.

Alternatively, the image processing device 1 may be implemented as a computer device including a CPU, ROM (Read-Only Memory), and RAM (Random Access Memory). The image processing device 1 may be implemented as a computer device including an input-output connection circuit (IOC: Input and Output Circuit) in addition to the above configuration. The image processing device 1 may be implemented as a computer device including a network interface circuit (NIC: Network Interface Circuit) in addition to the above configuration.

Alternatively, the image processing device 1 may be implemented as a computer device further including an arithmetic unit for performing calculations for a part of or all of the processing related to tracking, such as feature calculation and inference.

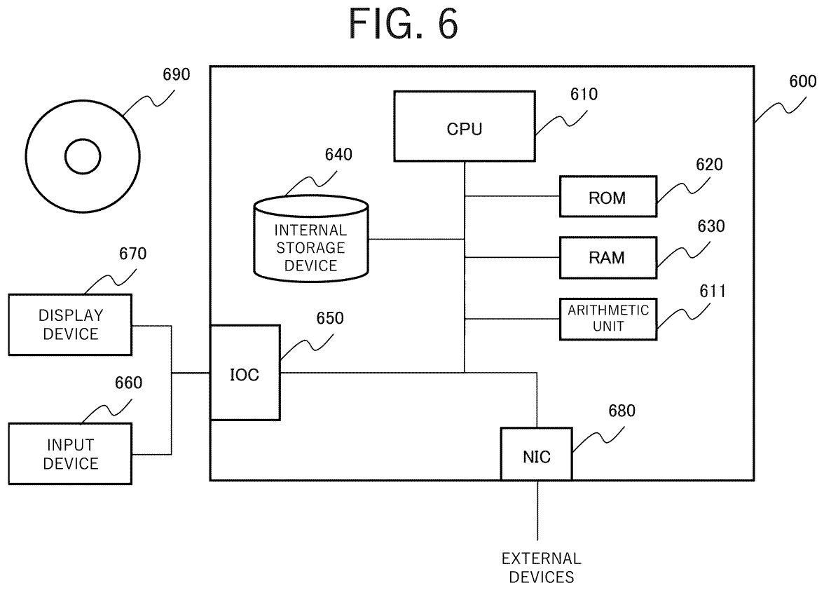

FIG. 6 is a block diagram showing an example hardware configuration of an information processing device 600 that can be used as the image processing device 1.

The information processing device 600 includes a CPU 610, an arithmetic unit 611, ROM 620, RAM 630, an internal storage device 640, IOC 650, and NIC 680. The information processing device 600 constitutes a computer device.

The CPU 610 reads programs from the ROM 620 and/or the internal storage device 640. The CPU 610 controls the RAM 630, the internal storage device 640, the arithmetic unit 611, the IOC 650, and the NIC 680 based on the read programs. The computer device including the CPU 610 realizes the functions of the object position prediction unit 10, the object detection target area determination unit 20, the first object detection unit 30, the second object detection unit 40, and the object position storage unit 50 by controlling these configurations.

The CPU 610 may use the RAM 630 or the internal storage device 640 as a temporary storage medium for the programs when realizing the functions.

Additionally, the CPU 610 may read the programs included in a storage medium 690 that stores programs readable by a computer using an unillustrated storage medium reading device. Alternatively, the CPU 610 may receive the programs from an external device via the NIC 680 and store them in the RAM 630 or the internal storage device 640, and operate based on the stored programs.

The arithmetic unit 611 may be a GPU (Graphics Processing Unit), FPGA (Field-Programmable Gate Array), ASIC (Application-Specific Integrated Circuit), or AI (Artificial Intelligence) chip. The arithmetic unit 611 may perform calculations for a part of or all of the processing, such as object detection and prediction inference, under the control of programs executed by the CPU 610. The data, programs, circuit information, etc., required for the execution of the arithmetic unit 611 may be stored in the ROM 620, the RAM 630, the internal storage device 640, etc.

The ROM 620 stores programs and fixed data executed by the CPU 610. The ROM 620 may be a P-ROM (Programmable-ROM) or flash ROM.

The RAM 630 temporarily stores programs and data executed by the CPU 610. The RAM 630 may be a D-RAM (Dynamic-RAM).

The internal storage device 640 stores data and programs that the information processing device 600 stores long-term. The internal storage device 640 may operate as the object position storage unit 50. Additionally, the internal storage device 640 may operate as a temporary storage device for the CPU 610. The internal storage device 640 may be a hard disk device, magneto-optical disk device, SSD (Solid State Drive), or disk array device.

The ROM 620 and the internal storage device 640 are non-transitory recording media. On the other hand, the RAM 630 is a transitory recording medium. The CPU 610 can operate based on programs stored in the ROM 620, the internal storage device 640, or the RAM 630. In other words, the CPU 610 can operate using non-transitory or transitory recording media.

The IOC 650 intermediates data between the CPU 610 and the input device 660 and the display device 670. The IOC 650 may be an I/O interface card or a USB (Universal Serial Bus) card. Additionally, the IOC 650 may connect wirelessly as well as wired, such as USB.

The input device 660 receives instructions from an operator of the information processing device 600. For example, the input device 660 receives parameters. The input device 660 may be a keyboard, mouse, or touch panel. Additionally, the input device 660 may be an input device that functions as the image input unit 60. The image input unit 60 may be a camera device.

The display device 670 is a device that can display information to the operator of the information processing device 600. The display device 670 may be a liquid crystal display, an organic electroluminescence display, or electronic paper.

The NIC 680 relays data exchanges with external devices (not shown in FIG.) via a network. The NIC 680 may be a LAN (Local Area Network) card. The NIC 680 may connect wirelessly as well as wired to external devices.

The information processing device 600 configured in this way can obtain the same effects as the image processing device 1. This is because the CPU 610 of the information processing device 600 can realize the same functions as the image processing device 1 based on the programs. Additionally, the CPU 610 and the arithmetic unit 611 of the information processing device 600 can realize the same functions as the image processing device 1 based on the programs.

### Second Example Embodiment

Next, the second example embodiment of the present disclosure will be explained. The image processing device 1B according to the second example embodiment generates an aggregated image by collecting image areas of object detection target areas and performs object detection on the aggregated image.

The second example embodiment will be explained with reference to the drawings. In the description of the second example embodiment, the same reference numerals are assigned to configurations that perform the same operations as in the first example embodiment. Detailed descriptions of these configurations are omitted.

### Description of Configuration

The configuration of the image processing device 1B according to the second example embodiment will be explained with reference to the drawings. The image processing device 1B may be configured using a computer device as shown in FIG. 6, similar to the first example embodiment.

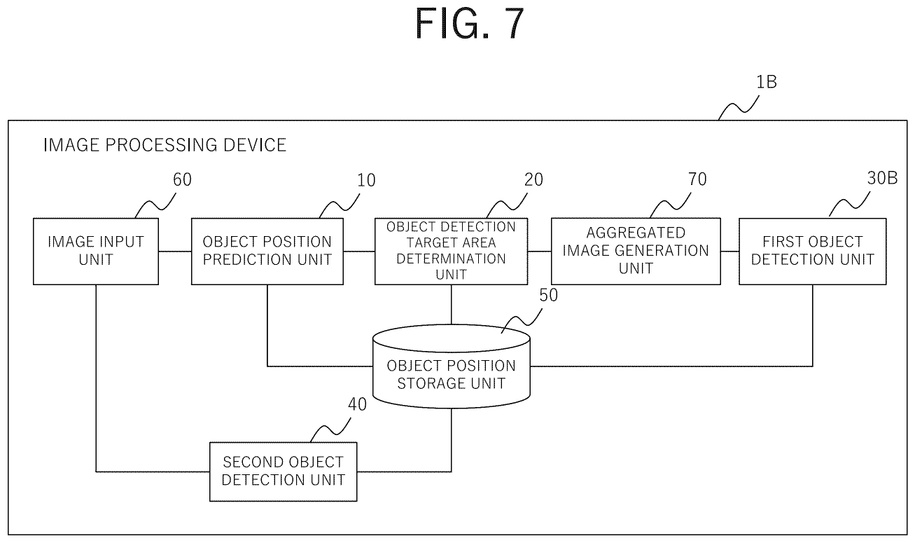

FIG. 7 is a block diagram showing an example configuration of the image processing device 1B according to the present disclosure.

The image processing device 1B shown in FIG. 7 includes the object position prediction unit 10, the object detection target area determination unit 20, a first object detection unit 30B, the second object detection unit 40, the object position storage unit 50, the image input unit 60, and an aggregated image generation unit 70.

The aggregated image generation unit 70 generates an aggregated image by collecting image areas of the object detection target areas. The aggregated image generation unit 70 receives information indicating the object detection target areas from the object detection target area determination unit 20 and generates an image (aggregated image) by collecting the image areas of the individual object detection target areas. The process of collecting (that is, copying) the obtained image areas is called Packing. The aggregated image generation unit 70 may generate one or more aggregated images. The aggregated image generation unit 70 associates the individual object detection target areas with the arrangement information of the individual object detection target areas on the aggregated image when generating the aggregated image. The aggregated image generation unit 70 may provide a predetermined width of gaps (intervals) between the image areas when performing Packing.

The aggregated image generation unit 70 may change (that is, enlarge or reduce) the size of the individual object detection target areas when copying them to the aggregated image during Packing. Reducing the size can reduce the number of aggregated images, potentially shortening the inference processing time for object detection. Enlarging the size can potentially improve recognition accuracy. The aggregated image generation unit 70 may decide whether to change the size of the individual object detection target areas and the size after the change based on predetermined thresholds or the like. For example, the aggregated image generation unit 70 may decide whether to change the size of the individual object detection target areas and the size after the change based on the area of the individual object detection target areas. The aggregated image generation unit 70 may perform image processing such as interpolation when changing the size of the individual object detection target areas. Additionally, the aggregated image generation unit 70 may perform arbitrary image processing in addition to or instead of changing the size of the image areas. The aggregated image generation unit 70 may perform image processing such as brightness adjustment, contrast adjustment, geometric correction, etc.

The first object detection unit 30B has the same functions as the first object detection unit 30 of the first example embodiment. However, the first object detection unit 30B uses the aggregated image generated by the aggregated image generation unit 70 as input instead of using the images of the individual object detection target areas as input.

### DESCRIPTION OF OPERATION

Next, an example operation of the image processing device 1B according to the second example embodiment will be explained with reference to the drawings. In the image processing device 1B according to the second example embodiment, the same steps as the image processing device 1 in the first example embodiment are given the same step numbers, and detailed descriptions of these steps are omitted.

### (A2) Operation of Object Detection Processing Based on Prediction

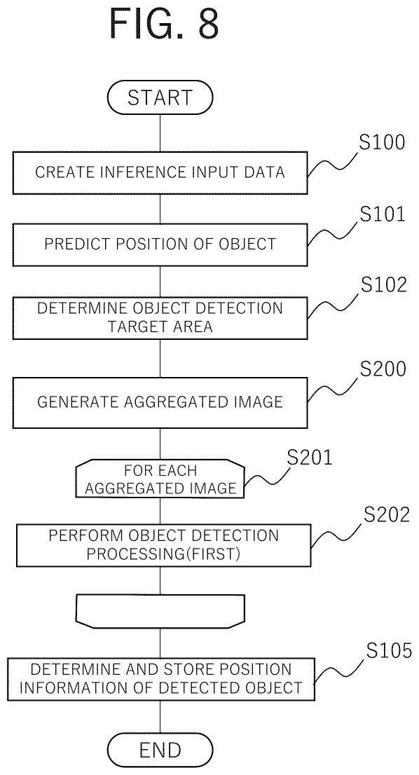

FIG. 8 is a flowchart showing an example operation of object detection processing in the image processing device 1B according to the present disclosure.

The image processing device 1B performs the processing of steps S100 to S102.

Next, the aggregated image generation unit 70 generates an aggregated image based on the object detection target areas obtained in step S102 (step S200).

Next, the first object detection unit 30B performs object detection processing for each aggregated image obtained in step S200 using the aggregated image (steps S201 to S202). For example, the first object detection unit 30B performs object detection processing using the aggregated image as input. The first object detection unit 30B converts the bounding box information obtained as the result of the object detection processing from coordinates in the aggregated image to coordinates in the input image input from the image input unit 60. The processing of step S202 is repeated until it is executed for all aggregated images.

The image processing device 1B according to the second example embodiment performs the following operations (B) and (C) from the first example embodiment, replacing the operations for each individual object detection target area with the operations for each aggregated image, similar to the aforementioned operation (A2) for object detection processing based on prediction.

### (B) Operation of Object Detection Processing Using the Second Object Detection Unit

(C) Operation of Object Detection Processing Using Information about a New Object

### DESCRIPTION OF EFFECTS

Next, the effects of the second example embodiment will be explained.

The image processing device 1B according to the second example embodiment can improve the throughput of object detection processing, similar to the first example embodiment. Additionally, the image processing device 1B according to the second example embodiment can shorten the delay in object detection processing.

The image processing device 1B generates aggregated images based on individual object detection target areas. Next, the image processing device 1B performs object detection for each aggregated image. The size of the aggregated images is expected to be smaller than the input images. Therefore, the image processing device 1B according to the second example embodiment reduces the amount of data to be processed for object detection, thereby reducing the computational load. Therefore, the throughput of object detection processing is expected to improve. Additionally, the delay in object detection processing is expected to shorten. In other words, the image processing device 1B according to the second example embodiment enables quick responses to target objects by shortening the time from when the target objects appear in the images to when they are detected (that is, shortening the delay).

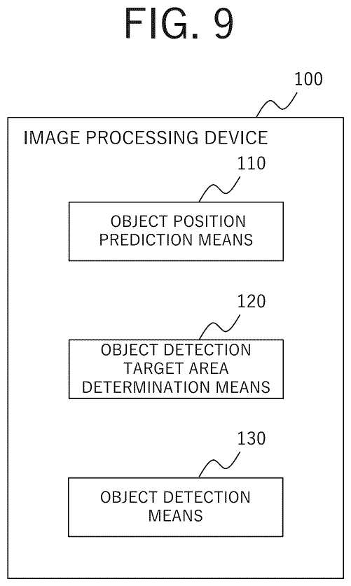

Next, the outline of the present disclosure will be explained. FIG. 9 is a block diagram showing an overview of the image processing device according to the present disclosure. The image processing device 100 (in the example embodiments, the image processing device 1 or the image processing device 1B) shown in FIG. 9 includes an object position prediction means 110 (realized by the object position prediction unit 10 in the example embodiments) that predicts a position of an object in a new input image based on a position of the object detected in a past input image, an object detection target area determination means 120 (realized by the object detection target area determination unit 20 in the example embodiments) that determines an object detection target areas in new input images based on the prediction results by the object position prediction unit 110, and an object detection means 130 (realized by the first object detection unit 30 or the first object detection unit 30B in the example embodiments) that performs object detection on the object detection target areas determined by the object detection target area determination unit 120. The size of the object detection target area is expected to be smaller than the input image. In other words, the image processing device 100 reduces the amount of data to be processed for object detection, thereby reducing the computational load. Therefore, the throughput of object detection processing is expected to improve. Additionally, the delay in object detection processing is expected to shorten.

A part of or all of the above example embodiments may also be explained as follows, but are not limited to the following.
(Supplementary note 1) An image processing device includes an object position prediction means that predicts a position of an object in a new input image based on a position of the object detected in a past input image, an object detection target area determination means that determines an object detection target area in the new input image based on the prediction result of the object position prediction means, and an object detection means that performs object detection on the object detection target area determined by the object detection target area determination means.
(Supplementary note 2) The image processing device according to supplementary note 1, further includes a second object detection means that performs object detection on the new input image, wherein the object detection target area determination means updates the object detection target area based on the object detection result of the second object detection means.
(Supplementary note 3) The image processing device according to supplementary note 2 or supplementary note 2, wherein the object detection target area determination means identifies a new object that is not included in the object detection target area determined based on the prediction result of the object position prediction means, among the objects detected by the second object detection means, and updates the object detection target area to include the identified new object.
(Supplementary note 4) The image processing device according to supplementary note 3, wherein the object detection target area determination means updates the object detection target area to include the new object whose position information has been updated based on the object detection result of the object detection means.
(Supplementary note 5) The image processing device according to any one of supplementary notes 1 to 4, wherein the object position prediction means uses independent information for each time point when using position information of objects detected in a plurality of input images generated at different times as input for prediction.
(Supplementary note 6) An image processing method comprising predicting a position of an object in a new input image based on a position of the object detected in a past input image, determining an object detection target area in the new input image based on the prediction result, and performing object detection on the determined object detection target area.
(Supplementary note 7) The image processing method according to supplementary note 6, further comprising performing a second object detection on the new input image, and updating the object detection target area based on the object detection result of the second object detection.
(Supplementary note 8) The image processing method according to supplementary note 6 or supplementary note 7, wherein identifying a new object that is not included in the object detection target area determined based on the prediction result, among the objects detected by the second object detection, and updating the object detection target area to include the identified new object.
(Supplementary note 9) The image processing method according to supplementary note 8, wherein updating the object detection target area to include the new object whose position information has been updated based on the object detection result of the object detection.
(Supplementary note 10) The image processing method according to any one of supplementary notes 6 to 9, wherein using independent information for each time point when using position information of objects detected in a plurality of input images generated at different times as input for prediction.
(Supplementary note 11) An image processing program for causing a computer to execute an object position prediction process that predicts a position of an object in a new input image based on a position of the object detected in a past input image, an object detection target area determination process that determines an object detection target area in the new input image based on the prediction result of the object position prediction process, and an object detection process that performs object detection on the object detection target area determined by the object detection target area determination process.
(Supplementary note 12) The image processing program according to supplementary note 11, for causing a computer to execute a second object detection process that performs object detection on the new input image, wherein the object detection target area determination process updates the object detection target area based on the object detection result of the second object detection process.
(Supplementary note 13) The image processing program according to supplementary note 11 or Supplementary note 12, wherein the object detection target area determination process identifies a new object that is not included in the object detection target area determined based on the prediction result of the object position prediction process, among the objects detected by the second object detection process, and updates the object detection target area to include the identified new object.
(Supplementary note 14) The image processing program according to supplementary note 13, wherein the object detection target area determination process updates the object detection target area to include the new object whose position information has been updated based on the object detection result of the object detection process.
(Supplementary note 15) The image processing program according to any one of supplementary notes 11 to 14, wherein the object position prediction process uses independent information for each time point when using position information of objects detected in a plurality of input images generated at different times as input for prediction.

The present disclosure is suitable for image processing using inference by machine learning.

As described above, the present disclosure has been explained with reference to the example embodiments, but the present disclosure is not limited to the above example embodiments. Various changes can be made to the configuration and details of the present disclosure within the scope of understanding of those skilled in the art. Each example embodiment can be appropriately combined with other example embodiments.

1. An image processing device comprising:
a memory storing software instructions; and
one or more processors configured to execute the software instructions to:
predict a position of an object in a new input image based on a position of the object detected in a past input image;
determine an object detection target area in the new input image based on the prediction result; and
perform object detection on the determined object detection target area.

2. The image processing device according to claim 1, wherein the one or more processors are further configured to execute the software instructions to:
perform a second object detection on the new input image; and
update the object detection target area based on the object detection result of the second object detection.

3. The image processing device according to claim 2, wherein
the one or more processors identify a new object that is not included in the object detection target area determined based on the prediction result, among the objects detected by the second object detection, and update the object detection target area to include the identified new object.

4. The image processing device according to claim 3, wherein
the one or more processors update the object detection target area to include the new object whose position information has been updated based on the object detection result of the object detection.

5. The image processing device according to claim 1, wherein
the one or more processors use independent information for each time point when using position information of objects detected in a plurality of input images generated at different times as input for prediction.

6. An image processing method, implemented by a processor, comprising:
predicting a position of an object in a new input image based on a position of the object detected in a past input image;
determining an object detection target area in the new input image based on the prediction result; and
performing object detection on the determined object detection target area.

7. The image processing method according to claim 6, further comprising
performing a second object detection on the new input image, and
updating the object detection target area based on the object detection result of the second object detection.

8. The image processing method according to claim 7, wherein
identifying a new object that is not included in the object detection target area determined based on the prediction result, among the objects detected by the second object detection, and updating the object detection target area to include the identified new object.

9. The image processing method according to claim 8, wherein
updating the object detection target area to include the new object whose position information has been updated based on the object detection result of the object detection.

10. The image processing method according to claim 6, wherein
using independent information for each time point when using position information of objects detected in a plurality of input images generated at different times as input for prediction.

11. A non-transitory computer readable storage medium for storing an image processing program for causing a computer to execute:
an object position prediction process that predicts a position of an object in a new input image based on a position of the object detected in a past input image;
an object detection target area determination process that determines an object detection target area in the new input image based on the prediction result of the object position prediction process; and
an object detection process that performs object detection on the object detection target area determined by the object detection target area determination process.

12. The non-transitory computer readable storage medium according to claim 11, wherein
the image processing program causes the computer to execute
a second object detection process that performs object detection on the new input image,
wherein the object detection target area determination process updates the object detection target area based on the object detection result of the second object detection process.

13. The non-transitory computer readable storage medium according to claim 12, wherein
the object detection target area determination process identifies a new object that is not included in the object detection target area determined based on the prediction result of the object position prediction process, among the objects detected by the second object detection process, and updates the object detection target area to include the identified new object.

14. The non-transitory computer readable storage medium according to claim 13, wherein
the object detection target area determination process updates the object detection target area to include the new object whose position information has been updated based on the object detection result of the object detection process.

15. The non-transitory computer readable storage medium according to claim 11, wherein
the object position prediction process uses independent information for each time point when using position information of objects detected in a plurality of input images generated at different times as input for prediction.

16. The image processing device according to claim 2, wherein
the one or more processors use independent information for each time point when using position information of objects detected in a plurality of input images generated at different times as input for prediction.

17. The image processing device according to claim 3, wherein
the one or more processors use independent information for each time point when using position information of objects detected in a plurality of input images generated at different times as input for prediction.

18. The image processing device according to claim 4, wherein
the one or more processors use independent information for each time point when using position information of objects detected in a plurality of input images generated at different times as input for prediction.
